(19) United States
(12) Patent Application Publication
(10) Pub. No.: US 2016/0282935 A1
(43) Pub. Date: Sep. 29, 2016

(54) Finger-wearable Input Device

(71) Applicant: Tsai-Hsien YANG, Taoyuan City (TW)

(72) Inventor: Tsai-Hsien YANG, Taoyuan City (TW)

(21) Appl. No.: 14/695,508

(22) Filed: Apr. 24, 2015

(30) Foreign Application Priority Data
Mar. 23, 2015 (TW) 104204301

(51) Int. Cl. G06F 3/01; G06F 3/0354

(52) U.S. Cl. CPC G06F 3/011; G06F 3/03543

(57) ABSTRACT

The present invention relates to a finger-wearable input device. The finger-wearable input device includes an operative bulk configured to wear on a finger of a user and comprising a main board module, on which main board module a motion sensor and a first action button are disposed for generating a wireless signal with respect to a mouse event; and a battery module configured to be separated from the operative bulk but electrically connected with the main board module.

### FIELD

The present invention relates to a wearable input device. In particular, it relates to a finger-wearable input device, which has a function in common with that of an air mouse device.

### BACKGROUND

Recently, with the tremendous and rapid development in the field of micro electromechanical systems (MEMS) technology, various motion sensors, covering such as an accelerometer, a gyroscope and so forth, have continuously advanced and prosperously developed, which directly facilitates emergence of an air mouse product. The air mouse product is capable of straightforwardly commanding a cursor on a screen in the air, just as an optical mouse or a wheeled mouse ordinarily does, by sensing a user's gestures through a MEMS-based motion sensor built in the air mouse product.

In the state of the art, an air mouse product available on the market has a typical structure designed to be as similar as possible to that of a conventional desktop mouse, in order to meet enormous consumers' long-term formed habit on operating a desktop mouse. Thus it often appears a left button, a right button and a central scroll wheel arranged on the operative panel. The air mouse is usually manufactured to have a rectangular appearance like a bar-type remote controller or a laser pointer, and a user can well grasp the air mouse by a single hand. A user operates the air mouse simply with gestures or hand movements. A cursor on the screen moves correspondingly and accordingly, as the air mouse moves through space and time. A user can use fingers to press or touch the left button, the right button or the scroll wheel on the operative panel, to generate a series of mouse events, such as an item drag, an item selection, a position movement, a single-click or a double-click.

FIG. 1 is a schematic diagram illustrating a structure for a conventional air mouse. The conventional air mouse 100 has an operative panel 110 disposed with a left button 120, a right button 130, a central scroll wheel 140 and a housing 160. The mouse 100 has been manufactured to have a streamline modern appearance and a grasping portion 150 for handheld. The movements of the air mouse 100 in three-dimension space are detected by motion sensors built in the mouse, such as a gyroscope. Furthermore, in the conventional air mouse 100, every component, such as a wireless communication module, a main board module and a battery module are designed to be encompassed in the housing 160.

A Lagrangian field theory is employed to define three axes in Cartesian coordinate system used in the air mouse 100. That is, the observation point or the original point of the Cartesian coordinate system is always based on the mouse 100 and follows it as it moves through space and time. Accordingly, it defines the axis along the longitudinal direction as an X axis, the axis along the lateral direction as a Y axis and the axis along the vertical direction as a Z axis. It defines as a roll action as if the mouse 100 revolves or rolls based on the X axis, defines as a pitch action as if the mouse 100 revolves or pitches based on the Y axis and defines as a yaw action as if the mouse 100 revolves or yaws based on the Z axis.

However, the conventional air mouse has several apparent defects as follows. The conventional air mouse is designed to contain and collect every component including the very heavy battery module inside the housing, which causes entire mouse heavy and cumbersome. Even if just using the mouse for a moment, a user easily feels wrist aches and uncomfortable. Due to the heavy device weight, the conventional air mouse is totally unsuitable for a long time operation.

In addition, the conventional air mouse is operated in the air and requires none of supporting structures underneath the air mouse, and therefore it can be operated free from a use of a desktop and without a support from a desktop. But in nature, a human's wrist fails to perform a micro and sophisticated movement without an appropriate support underneath, which causes it very difficult to exactly move a cursor to a specific position or point or to align with certain icon or mark. Hence it is apparent that the design to the conventional air mouse is not in conformity with the ergonomics.

As if a user starts to operate the mouse and touches such as the left button, the right button or the scroll wheel on the operative panel, due to the heavy device weight and the lack of supports underneath, even thought the user just touches the button very gently, the force sourced from the user's touch unavoidably results in a tremble and instability to the mouse. Even a very slight tremble and instability occurring to the mouse, the cursor shown on the screen must correspondingly deviate from the desired or target position. Hence, it is hard to stably and precisely manipulate the conventional air mouse and the conventional air mouse totally lacks of stability, maneuverability and accuracy during an operation.

There is a need to solve the above deficiencies/issues.

### SUMMARY

The present invention provides a finger-wearable input device includes multiple separated parts including a primary body (an operating bulk) and a battery (batter module) which are separated from each other.

The present invention relates to a separate type finger-wearable input device, which is also referred to as a split type finger-wearable input device. The primary body and the battery included in the device are arranged in separation, and therefore the primary body has a relatively lighter weight and a relatively smaller volume, as compared with that of the conventional air mouse. Thus the primary body becomes small and light enough to be wore on a thumb finger. The battery is separated and contained in a specific bag wore and fastened on a hand wrist or an arm by a Velcro strap, but the battery is still in an electrical connection with the primary body. Subject to this separation configuration, a user just demands to gently and easily move the primary body wore on the thumb finger to operate the finger-wearable input device, and no longer to move the heavy and cumbersome battery.

Furthermore,

This finger-wearable input device includes an operative bulk configured to wear on a finger of a user and including a main board module, on which main board module a motion sensor and a first action button are disposed for generating a wireless signal with respect to a mouse event; and a battery module configured to be separated from the operative bulk but electrically connected with the main board module.

Preferably, finger-wearable input device further includes a fabric bag containing the battery module and capable of fastening on any part of the user.

### DESCRIPTION OF THE DRAWINGS

A more complete appreciation of the invention and many of the attendant advantages thereof are readily obtained as the same become better understood by reference to the following detailed description when considered in connection with the accompanying drawing, wherein:

FIG. 1 is a schematic diagram illustrating a structure for a conventional air mouse;

FIG. 2 is a schematic diagram illustrating a Lagrangian-based Cartesian coordinate system used for the finger-wearable device according to the present invention;

FIG. 3(a) is a top-viewed schematic diagram illustrating a topside structure for the finger-wearable input device according to the present invention;

FIG. 3(b) is a foreside-viewed schematic diagram illustrating a foreside structure for the finger-wearable input device according to the present invention;

FIG. 3(c) is a bottom-side-viewed schematic diagram illustrating a bottom-side structure for the finger-wearable input device according to the present invention;

FIG. 3(d) is a first side-viewed schematic diagram illustrating a first lateral structure for the finger-wearable input device according to the present invention;

FIG. 3(e) is a second side-viewed schematic diagram illustrating a second lateral structure for the finger-wearable input device according to the present invention;

FIG. 4 is a schematic diagram illustrating the operative bulk and the batter module which are arranged to separate from each other according to the present invention; and

FIG. 5 is a schematic diagram illustrating the operative bulk and the batter module separate from each other are arranged to be respectively wore on the thumb finger and the hand wrist.

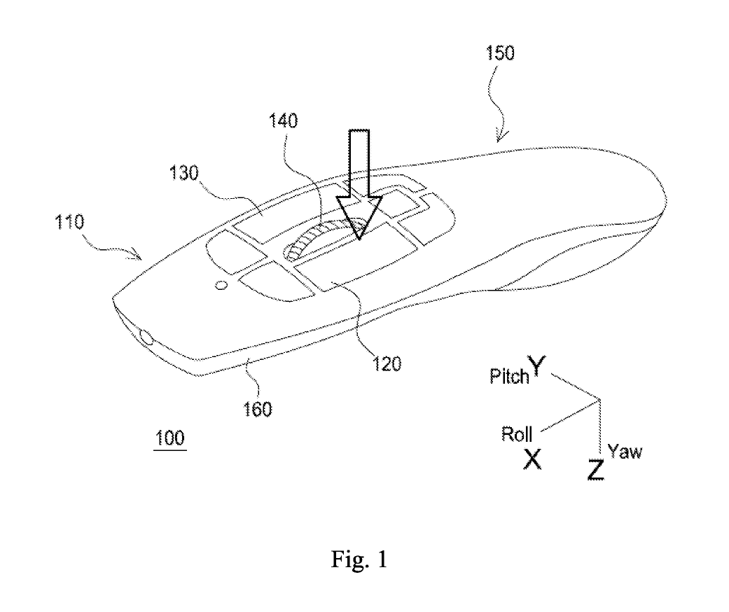

### DETAILED DESCRIPTION

The present disclosure will be described with respect to particular embodiments and with reference to certain drawings, but the disclosure is not limited thereto but is only limited by the claims. The drawings described are only schematic and are non-limiting. In the drawings, the size of some of the elements may be exaggerated and not drawn on scale for illustrative purposes. The dimensions and the relative dimensions do not necessarily correspond to actual reductions to practice.

It is to be noticed that the term “comprising” or “including”, used in the claims and specification, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression “a device including means A and B” should not be limited to devices consisting only of components A and B.

The disclosure will now be described by a detailed description of several embodiments. It is clear that other embodiments can be configured according to the knowledge of persons skilled in the art without departing from the true technical teaching of the present disclosure, the claimed disclosure being limited only by the terms of the appended claims.

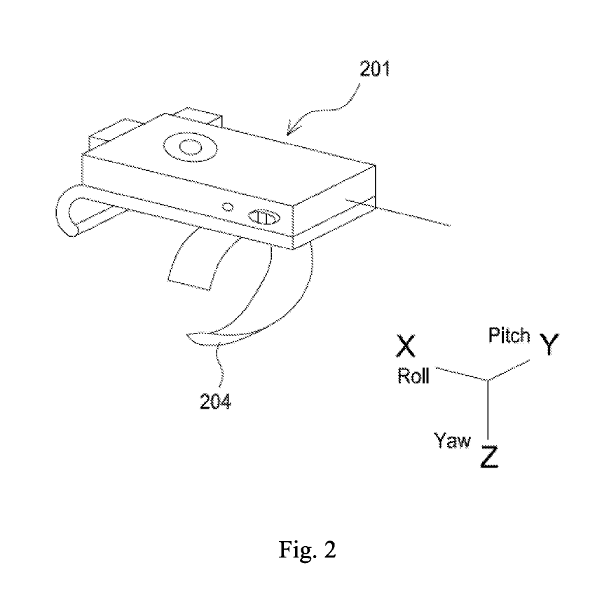

FIG. 2 is a schematic diagram illustrating a Lagrangian-based Cartesian coordinate system used for the finger-wearable device according to the present invention. In the present invention, a Lagrangian field theory is employed to define three axes in Cartesian coordinate system used for the finger-wearable input device 200 according to the present invention. That is, the observation point or the original point of the Cartesian coordinate system is always fixed on the operative bulk 201 of the device 200 and follows it as it moves through space and time. Accordingly, it defines the axis along the longitudinal direction as an X axis, the axis along the lateral direction as a Y axis and the axis along the vertical direction as a Z axis. It defines as a roll action as if the operative bulk 201 revolves or rolls based on the X axis, defines as a pitch action as if the operative bulk 201 revolves or pitches based on the Y axis and defines as a yaw action as if the operative bulk 201 revolves or yaws based on the Z axis.

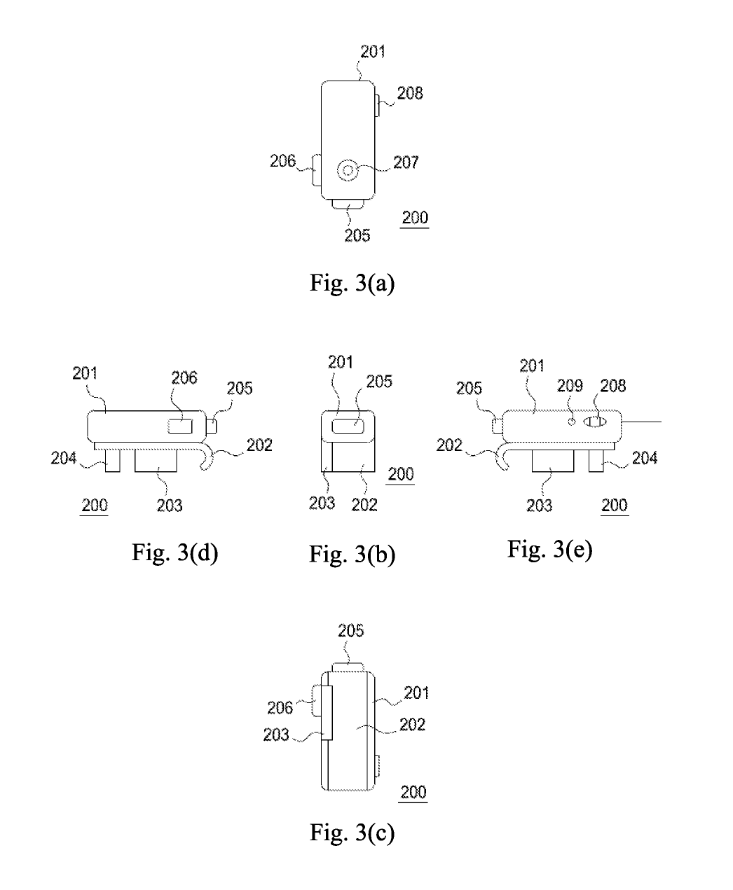

Please refer to FIG. 3(a) to FIG. 3(e) at the same time. FIG. 3(a) is a top-viewed schematic diagram illustrating a topside structure for the finger-wearable input device according to the present invention. FIG. 3(b) is a foreside-viewed schematic diagram illustrating a foreside structure for the finger-wearable input device according to the present invention. FIG. 3(c) is a bottom-side-viewed schematic diagram illustrating a bottom-side structure for the finger-wearable input device according to the present invention. FIG. 3(d) is a first side-viewed schematic diagram illustrating a first lateral structure for the finger-wearable input device according to the present invention. FIG. 3(e) is a second side-viewed schematic diagram illustrating a second lateral structure for the finger-wearable input device according to the present invention.

The finger-wearable input device 200 according to the present invention includes an operative bulk 201. The operative bulk 201 is preferably a case body having a containing space inside for containing a main board module. There are a chip set of accelerometer, a chip set of dual-axis gyroscope and a chip set of Bluetooth installed on the main board module, which chip sets are preferably fabricated by a Micro Electro-Mechanical Systems (MEMS) process. The dual-axis gyroscope is used for detecting a yaw angle and a pitch angle for the operative bulk 201, and the accelerometer is used for detecting a yaw speed and a pitch speed for the operative bulk 201. The detected yaw angle, pitch angle, yaw speed and pitch speed are used for calculating coordinate-related information for cursor and belong to a mouse event.

A wireless signal with respect to the mouse event is then wirelessly transmitted to an externally linked device, such as a smart phone, a tablet computer, a desktop computer, a laptop computer, a television, a set top box, a head mounted display or an electronic device with a screen, through the chip set of Bluetooth. After the externally linked device receives the wireless signal with respect to the mouse event, it calculates a vector-based displacement according to the detected yaw angle, pitch angle, yaw speed and pitch speed contained in the received wireless signal, to move a cursor on the screen accordingly, or performs a task according to the wireless signal.

There are a foreside protrusion 202, a side protrusion 203 and a fasten strap 204 further disposed on the operative bulk 201. The fasten strap 204 is preferably a hook and loop strap or a Velcro strap. The foreside protrusion 202 and the side protrusion 203 form and define a finger space on the operative bulk 201 having a size suitable for settling down a finger, preferably a thumb finger. The operating bulk 201 is then secured onto the thumb finger by the fasten strap 204. After the operating bulk 201 fixed, as long as the user moves the thumb finger, the cursor shown on the screen on the externally linked device correspondingly moves.

There is a front button (a first action button) 205 and a side button (a second action button) 206 further disposed on the operative bulk 201. In this embodiment, the front button 205 is defined the same as and having the same function as a left button on an ordinary mouse input device, and the side button 206 is defined the same as and having the same function as a right button on an ordinary mouse input device. Both the front button 205 and the side button 206 are electrically connected with the main board module inside the operative bulk 201. There is a track panel 207 further disposed on the operative bulk 201, such as an infrared track panel, a blue ray track panel, a touch pad or a track pad. In this embodiment, the track panel 207 is defined the same as and having the same function as a scroll wheel on an ordinary mouse input device. When a user operates the front button 205, the side button 206 or the track panel 207, a mouse event, such as an item drag, an item selection, a position movement, a single-click, a double-click or a combination thereof, is generated and transmitted back to the main board module.

Furthermore, there are a power switch 208 and a Bluetooth switch 209 disposed on the lateral side of the operative bulk 201. The power switch 208 is used for activating or deactivating the input device 200. A user can turn off the input device 200 at any time, which is helpful for saving the power of battery. The Bluetooth switch 209 is preferably disposed in proximity to the power switch 208. When the input device 200 requires a wireless linkage with the externally linked device, a user can touch this Bluetooth switch 209 to turn on the Bluetooth function.

It is noticed that the battery module used for providing electric power to drive the operative bulk 201 is configured or arranged to split or separate from the operative bulk 201, and to electrically connect with the operative bulk 201 through a soft electric wire. Thus the present finger-wearable input device 200 is also referred to as a separate-type or a split-type finger-wearable input device.

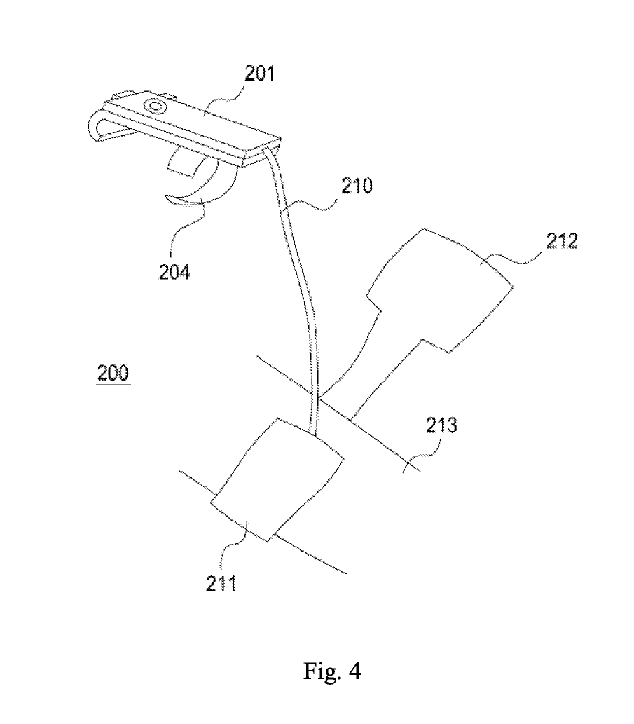

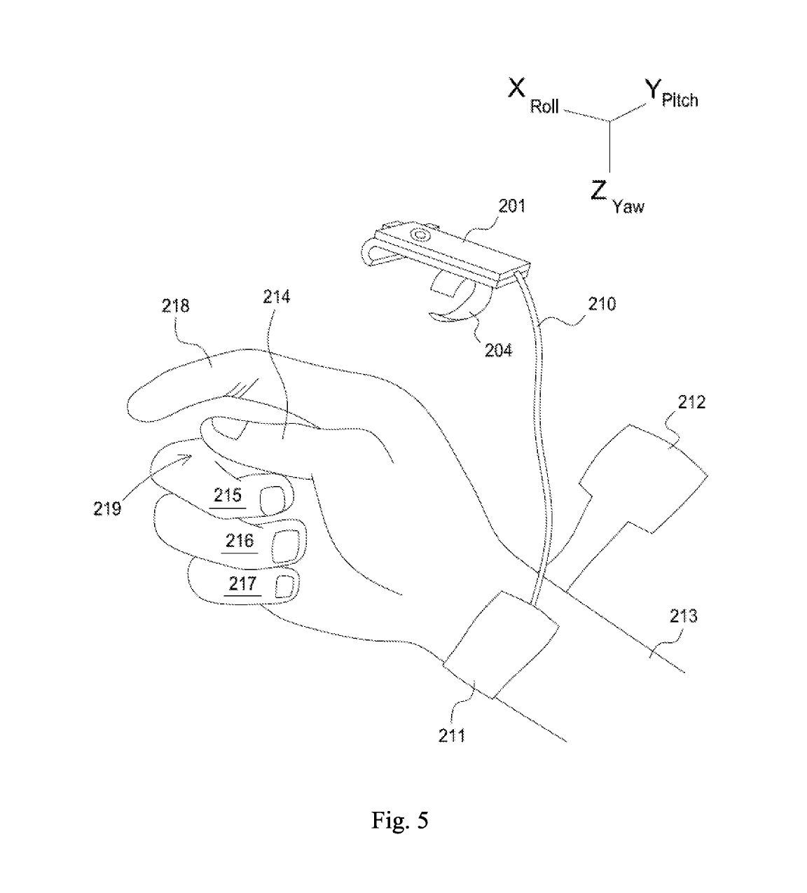

Please refer to FIG. 4 and FIG. 5 at the same time. FIG. 4 is a schematic diagram illustrating the operative bulk and the batter module which are arranged to separate from each other according to the present invention. FIG. 5 is a schematic diagram illustrating the operative bulk and the batter module separate from each other are arranged to be respectively wore on the thumb finger and the hand wrist. The operative bulk 201 and the battery module according to the present invention are electrically connected with each other through a soft electric wire 210. The operative bulk 201 is wore on the user's thumb finger and the battery module is contained in the fabric bag 211 which is manufactured as, such as a wristband, a hand band or a armband, and wore on the user's hand wrist 213 or arm which is fastened by a hook and loop strap 212 or a Velcro strap.

In brief, an actual scenario the finger-wearable input device 200 according to the present invention operates is as follows. Initially, a user wears and fastens the fabric bag 211 containing the battery module onto the hand wrist 213 by a hook and loop strap 212 and then wears and fastens up the operative bulk 201 onto the thumb finger 214 by the fasten strap 204. Next the user curls the middle finger 215, the third finger 216 and the little finger 217 into a fist to form a platform 219 right above the middle finger 215 and then places the thumb finger 214 wore with the operative bulk 201 onto the platform 219. Then the index finger 218 is response for operating the operative bulk. The user moves the index finger 218 to press the power switch button and Bluetooth button to turn on and activate the operative bulk 201 and Bluetooth connection with the externally linked device having a screen, such as a smart phone, a tablet computer, a laptop computer, a television, a set top box or a head-mounted display.

After the Bluetooth connection with the externally linked device is completed, a user commands the cursor on the screen moving to a desired position by easily and simply correspondingly moving the thumb finger 214. The user uses the index finger 218 to operate the front the front button (acting similarly as a left button on an ordinary mouse), the side button (acting similarly as a right button on an ordinary mouse) and the track panel (acting similarly as a scroll wheel on an ordinary mouse), to generate multiple desired mouse events, such as an item drag, an item selection, a position movement, a single-click or a double-click etc., as the input orders. Since during the operating, the forces sourced from operations performed by the index finger primarily apply to the X axis, there is almost none of pitch-based and yaw-based torques applied to the other Y axis and Z axis, which means there is almost none of pitch-based and yaw-based actions occurring on the operative bulk.

It is noticed that the X axis (the axis along the longitudinal direction) on the operative bulk 201 according to the present invention is set up to be parallel with the thumb finger and the front button is set up through the X axis. Thus when a user presses the front button, there are almost none of pitch actions or yaw actions additionally occurring on the respective Y axis and Z axis. That is any operation to the front button can almost cause none of torques to the Y axis and Z axis. Hence the finger-wearable input device 200 owns excellent operative stability, as compared with the conventional no matter the air mouse or the some equivalent devices else.

To sum up, the finger-wearable input device according to the present invention introduces in a novel structure to separate the main board module from the heavy and cumbersome battery module. Therefore, the operative bulk containing the main board module can have a miniaturized volume which can be carried by and wore on the thumb finger. The battery module is put into a fabric bag on a band separated from the operative bulk and wore on the hand wrist fastened by a hook and loop strap or a Velcro strap on the band.

Based on the above structure, when actually operating the input device, a user just requires to slightly move the thumb finger or gently revolve the hand wrist to operate the small operative bulk wore on the thumb finger. The heavy and cumbersome battery module is left and placed in the fabric bag on the wrist, which battery module is separated from the operating bulk on the thumb finger and thus causes none of influences to the movements of the operative bulk. Therefore, the user can almost control and operate the operative bulk to control the entire input device easily and effortlessly. On the contrary, in the conventional air mouse structure, a user has to carry or move the heavy and cumbersome battery module by his/her own hand when operating the air mouse, which relatively consumes the user more efforts and decreases the operative stability. Therefore, the finger-wearable input device according to the present invention owns quite outstanding operative stability, operative accuracy and maneuverability, as compared to the conventional air mouse.

There are further embodiments provided as follows.

Embodiment 1: A finger-wearable input device includes an operative bulk configured to wear on a finger of a user and including a main board module, on which main board module a motion sensor and a first action button are disposed for generating a wireless signal with respect to a mouse event; and a battery module configured to be separated from the operative bulk but electrically connected with the main board module.

Embodiment 2: The device as claimed in Embodiment 1 further includes a fabric bag containing the battery module and capable of fastening on any part of the user.

Embodiment 3: The device as described in Embodiment 1, the operative bulk further includes one of a containing space for containing the main board module; a foreside protrusion configured on the operative bulk; a side protrusion configured on the operative bulk wherein a finger space is defined by the foreside protrusion and the side protrusion, in which finger space the finger is settled; and a fasten strap configured on the operative bulk for fixing the operative bulk on the finger settled in the finger space.

Embodiment 4: The device as described in Embodiment 1, the operative bulk further includes one of a second action button configured on the operative bulk and electrically connected with the main board module; a power switch configured on the operative bulk and electrically connected with the main board module; a Bluetooth switch configured on the operative bulk and electrically connected with the main board module; and a track panel configured in the operative bulk and electrically connected with the main board module.

Embodiment 5: The device as described in Embodiment 4, the track panel is one selected from an infrared track panel, a blue ray track panel, a touch pad and a track pad.

Embodiment 6: The device as described in Embodiment 1, the main board module further includes a Bluetooth chip set for wirelessly communicating with an externally linked device for transmitting the wireless signal to the externally linked device.

Embodiment 7: The device as described in Embodiment 1, the externally linked device is one selected from a smart phone, a tablet computer, a desktop computer, a laptop computer, a television, a set top box and a head mounted display.

Embodiment 8: The device as described in Embodiment 1, the motion sensor further includes one of an accelerometer chip set for detecting a yaw speed and a pitch speed of the operative bulk; and a dual axis gyroscope chip set for detecting a yaw angle and a pitch angle of the operative bulk.

Embodiment 9: The device as described in Embodiment 1, the battery module is electrically connected with the main board module through a soft electric wire.

Embodiment 10: The device as described in Embodiment 1, the mouse event is one selected from an item drag, an item selection, a position movement, a single-click, a double-click and a combination thereof.

While the disclosure has been described in terms of what are presently considered to be the most practical and preferred embodiments, it is to be understood that the disclosure need not be limited to the disclosed embodiments. On the contrary, it is intended to cover various modifications and similar arrangements included within the spirit and scope of the appended claims, which are to be accorded with the broadest interpretation so as to encompass all such modifications and similar structures. Therefore, the above description and illustration should not be taken as limiting the scope of the present disclosure which is defined by the appended claims.

What is claimed is:

1. A finger-wearable input device, comprising:
an operative bulk configured to wear on a finger of a user and comprising a main board module, on which main board module a motion sensor and a first action button are disposed for generating a wireless signal with respect to a mouse event; and
a battery module configured to be separated from the operative bulk but electrically connected with the main board module.

2. The device as claimed in claim 1, further comprising:
a fabric bag containing the battery module and capable of fastening on any part of the user.

3. The device as claimed in claim 1, wherein the operative bulk further comprises one of:
a containing space for containing the main board module;
a foreside protrusion configured on the operative bulk;
a side protrusion configured on the operative bulk wherein a finger space is defined by the foreside protrusion and the side protrusion, in which finger space the finger is settled; and
a fasten strap configured on the operative bulk for fixing the operative bulk on the finger settled in the finger space.

4. The device as claimed in claim 1, wherein the operative bulk further comprises one of:
a second action button configured on the operative bulk and electrically connected with the main board module;
a power switch configured on the operative bulk and electrically connected with the main board module;
a Bluetooth switch configured on the operative bulk and electrically connected with the main board module; and
a track panel configured in the operative bulk and electrically connected with the main board module.

5. The device as claimed in claim 4, wherein the track panel is one selected from an infrared track panel, a blue ray track panel, a touch pad and a track pad.

6. The device as claimed in claim 1, wherein the main board module further comprises:
a Bluetooth chip set for wirelessly communicating with an externally linked device for transmitting the wireless signal to the externally linked device.

7. The device as claimed in claim 1, wherein the externally linked device is one selected from a smart phone, a tablet computer, a desktop computer, a laptop computer, a television, a set top box and a head mounted display.

8. The device as claimed in claim 1, wherein the motion sensor further comprises one of:
an accelerometer chip set for detecting a yaw speed and a pitch speed of the operative bulk; and
a dual axis gyroscope chip set for detecting a yaw angle and a pitch angle of the operative bulk.

9. The device as claimed in claim 1, wherein the battery module is electrically connected with the main board module through a soft electric wire.

10. The device as claimed in claim 1, wherein the mouse event is one selected from an item drag, an item selection, a position movement, a single-click, a double-click and a combination thereof.
